(19) United States
(12) Patent Application Publication
(10) Pub. No.: US 2013/0263734 A1
(43) Pub. Date: Oct. 10, 2013

(54) LOW-ENERGY PROCESS TO PRODUCE OXYGEN-ENRICHED AIR USING MEMBRANE TECHNOLOGY

(71) Applicants: Nicholas P. Wynn, Redwood City, CA (US); Haiqing Lin, Mountain View, CA (US); Meijuan Zhou, Fremont, CA (US); Jennifer H. Ly, San Jose, CA (US); Timothy C. Merkel, Menlo Park, CA (US)

(72) Inventors: Nicholas P. Wynn, Redwood City, CA (US); Haiqing Lin, Mountain View, CA (US); Meijuan Zhou, Fremont, CA (US); Jennifer H. Ly, San Jose, CA (US); Timothy C. Merkel, Menlo Park, CA (US)

(73) Assignee: MEMBRANE TECHNOLOGY AND RESEARCH, INC, Menlo Park, CA (US)

(21) Appl. No.: 13/439,716

(22) Filed: Apr. 4, 2012

(51) Int. Cl. B01D 53/22; B01D 71/04

(52) U.S. Cl. 95/54

(57) ABSTRACT

Disclosed herein is a process for producing oxygen-enriched air that involves a membrane separation step that uses glassy polymer membranes that have a selectivity to oxygen over nitrogen of at least 2.4.

### FIELD OF THE INVENTION

The invention relates to a low-energy process to produce oxygen-enriched air using membrane technology. The oxygen-enriched air can be used advantageously in combustion processes, such as kilns, or when using low-grade fuels, where reduction in ballast nitrogen is beneficial.

### BACKGROUND OF THE INVENTION

Oxygen enrichment is a flexible, efficient, and cost-effective technology that can improve all types of combustion processes, including those in lime or cement kilns or glass furnaces, combustion of fuel (e.g., coal, oil, biomass, or natural), or gasification processes. Oxygen enhances the combustion of all fuels, enabling improved burning zone control, greater kiln stability, and lower emissions. By increasing the oxygen concentration of combustion air through the addition of relatively pure oxygen, flame temperatures rise, heat transfer rates improve, and overall combustion efficiency increases. Or the same temperature can be reached, as in a kiln fed with “normal” air, as less ballast nitrogen has to be heated up to the kiln operating temperature.

Increasing the oxygen content of air provides advantages to any process in which inert nitrogen has a ballast effect. The benefit accrues even at only modest enrichment. For example, air with oxygen enriched from 21% to only 30%—an enrichment of only 9%—will contain nearly 40% less nitrogen per unit of oxygen. FIG. 1 is a graph that illustrates this effect.

Membrane technology can be used to produce oxygen-enriched air utilizing membranes that are preferentially permeable to oxygen over nitrogen. Conventional membrane technology for the production of oxygen-enriched air uses high-flux polydimethylsiloxane (PDMS) membranes (O₂:N₂ selectivity=2) with vacuum. To attain the optimum (desirable) oxygen enrichment of 30%, a vacuum of 0.25 bar abs is required. This cannot be attained with adiabatic vacuum pumps without ballast gas, so water ring pumps are used.

A water ring pump (also referred to as a liquid ring pump) is a rotating positive displacement pump. They are typically used as vacuum pumps, but can also be used as gas compressors. The function of a water ring pump is similar to a rotary vane pump—the difference being that the vanes are an integral part of the rotor and churn a rotating ring of liquid to form the compression chamber seal.

The water ring pump compresses gas by rotating a vaned impeller located eccentrically within a cylindrical casing. Water is fed into the pump and, by centrifugal acceleration, forms a moving cylindrical ring against the inside of the casing. This liquid ring creates a series of seals in the space between the impeller vanes, which form compression chambers. The eccentricity between the impeller's axis of rotation and the casing geometric axis results in a cyclic variation of the volume enclosed by the vanes and the ring.

Gas is drawn into the pump via an inlet port in the end of the casing. The gas is trapped in the compression chambers formed by the impeller vanes and the liquid ring. The reduction in volume caused by the impeller rotation compresses the gas, which reports to the discharge port in the end of the casing.

The use of water ring pumps in a process to produce oxygen-enriched air results in a high drive power because of:
High suction volume;
High pressure ratio; and
Inefficiency of the vacuum pump due, to frictional losses in the rapidly rotating water ring.

A basic process schematic for a conventional membrane-based process for producing oxygen-enriched air is shown in FIG. 2. According to this process, a feed air stream, 201, is passed at atmospheric pressure (approximately 1 bar) across the feed side of membranes, 203, in membrane unit, 202. Membranes 203 have a selective layer typically comprising a rubbery polymer (such as polydimethylsiloxane), having a selectivity for oxygen over nitrogen of about 2.

Oxygen-depleted residue stream, 204, exits the membrane unit. Oxygen-enriched permeate stream, 205, is withdrawn and is compressed in water ring vacuum pump, 208. In the compression process, the drive power is converted to heat energy, so cooling is, required to maintain a constant operating temperature. This cooling is provided by feeding cooled water, 206, to a port in the water ring pump. This water displaces some of the warmer ring water, which exits the ring as stream, 209.

This process uses approximately 900 kW to produce 10,000 Nm³/h of 29 vol % oxygen-enriched air. All vacuum pump drive power is lost to cooling water.

It would be desirable to have a more energy-efficient and simple process for the production of oxygen-enriched air.

### SUMMARY OF THE INVENTION

The process of the invention combines a higher oxygen/nitrogen selectivity (˜2.6), higher flux membrane operating with a less deep vacuum (0.42 bar abs), which is generated with a single-stage turbo vacuum blower. These pumps operate adiabatically and with a high efficiency, but are limited to this level of vacuum. The drive power is reduced from 900 kW to 400 kW (>55% saving) because of
Lower suction volume;
Lower pressure ratio; and
More efficient vacuum pump type (80% efficient).
   All vacuum pump drive power increases oxygen-enriched air gas temperature and enthalpy—a further advantage where the oxygen-enriched air is used to save furnace fuel.

Accordingly, disclosed herein is a process for producing oxygen-enriched air comprising the following steps:

(a) providing a source of air;

(b) providing a membrane having a feed side and a permeate side wherein the membrane has a selectivity for oxygen over nitrogen of at least 2.4;

(c) passing the air as a feed stream across the feed side of the membrane;

(d) withdrawing from the permeate side a permeate stream that is enriched in oxygen compared to the feed stream;

(e) compressing the permeate stream in a turbo vacuum blower; and

(f) withdrawing an oxygen-enriched air stream from the turbo vacuum blower exhaust.

The membrane preferably has a selectivity for oxygen over nitrogen of at least 2.5, and an oxygen permeance of at least about 2,000 gpu and, preferably, at least about 3,000 gpu. Membranes for use in the process of the invention typically have selective layers made from a hydrophobic fluorinated glassy polymer or copolymer.

The permeate stream typically has an oxygen content that is at least about 26 vol %, and preferably, at least about 28 vol %. The permeate stream is typically compressed in the turbo vacuum blower to at least atmospheric pressure. The resulting oxygen-enriched air stream is typically at a temperature within the range of about 110° C. to about 160° C. and, more typically, within the range of about 120° C. to about 140° C.

### BRIEF DESCRIPTION OF THE DRAWINGS

FIG. 1 is a graph illustrating the effect that increasing the oxygen content of air from 21% to 30% has on the ratio of nitrogen to oxygen in that air.

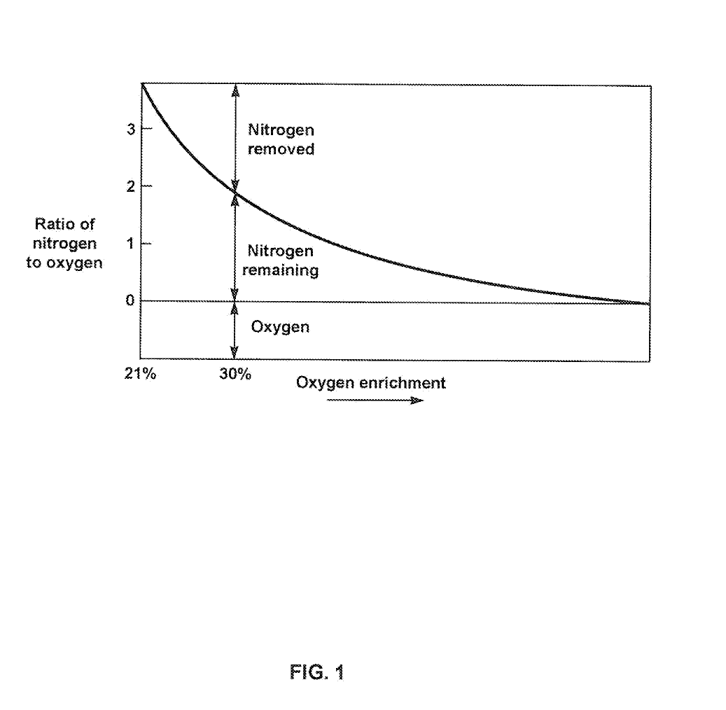

FIG. 2 is a basic process schematic for a conventional membrane-based process for producing oxygen-enriched air using a membrane having a polydimethylxiloxane (PDMS) selective layer (not in accordance with the invention).

FIG. 3 is a process schematic for a basic process of the invention for producing oxygen-enriched air using membrane having a glassy polymeric selective layer.

FIG. 4A is a graph showing permeate pressure (in bar abs) for a 29 vol % oxygen-enriched air production process, as well as specific power (in kWh/Nm³ EO₂) for a water ring vacuum pump process and a turbo vacuum blower process, as a function, of oxygen/nitrogen membrane selectivity. Nm³ EO₂ is the amount of Nm³ of oxygen in the enriched air in excess of that which would be present were the air not enriched in oxygen.

FIG. 4B is a graph showing permeate pressure (in bar abs) for a 30 vol % oxygen-enriched air production process, as well as specific power (in kWh/Nm³ EO₂) for a water ring vacuum pump process and a turbo vacuum blower process, as a function of oxygen/nitrogen membrane selectivity.

### DETAILED DESCRIPTION OF THE INVENTION

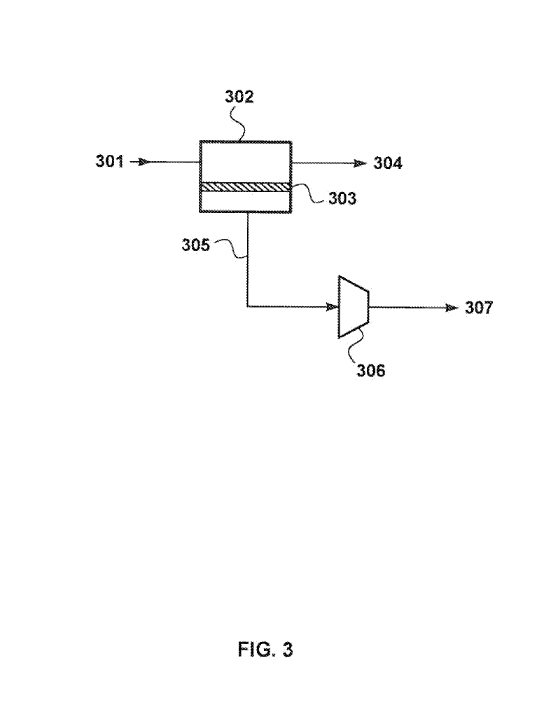

A basic embodiment of the invention that uses a glassy polymeric membrane in a process to produce oxygen-enriched air is shown in FIG. 3. According to this process, a feed air stream, 301, is passed across the feed side of membranes, 303, in membrane unit, 302. The membranes 303 have a selectivity for oxygen over nitrogen of at least 2.4 and, preferably, at least 2.5. The membranes also typically have an oxygen permeance of at least about 2,000 gpu and, preferably, at least about 3,000 gpu.

Particularly preferred membranes for use in the process of the invention have selective layers made from a hydrophobic fluorinated glassy polymer or copolymer. This polymer determines the membrane selectivity. Commercially available fluorinated polymers/copolymers that are suitable for use in the process of the present invention include Hyflon® AD (Solvay Solexis, Inc., Thorofare, N.J.); Cytop® (Asahi Glass Company, Tokyo, Japan); and Teflon® AF (DuPont, Wilmington, Del.).

The polymer chosen for the selective layer can be used to form films or membranes by any convenient technique known in the art, and may take diverse forms. The membrane may take the form of a homogeneous film, an integral asymmetric membrane, a multilayer composite membrane, a membrane incorporating a gel or liquid layer or particulates, or any other form known in the art. If super-glassy membranes are used, they may be formed as integral asymmetric or composite membranes.

Because the polymers are glassy and rigid, an unsupported film, tube, or fiber of the polymer is usable as a single-layer membrane. However, single-layer films will normally be too thick to yield acceptable transmembrane flux however, and, in practice, the separation membrane usually comprises a very thin selective layer that forms part of a thicker structure, such as an integral asymmetric membrane or a composite membrane.

The preferred form is a composite membrane. Modern composite membranes typically comprise a highly permeable, but relatively non-selective, support membrane that provides mechanical strength, coated with a thin selective layer of another material that is primarily responsible for the separation properties. Typically, but not necessarily, such a composite membrane is made by solution-casting, the support membrane, then solution-coating the selective layer. Preparation techniques for making composite membranes of this type are well known.

The membranes may be manufactured as flat sheets or as fibers and housed in any convenient module form, including spiral-wound modules, plate-and-frame modules, and potted hollow fiber modules. The making of all these types of membranes and modules is well-known in the art. Flat-sheet membranes in spiral-wound modules is the most preferred choice.

Membrane unit 302 may contain a single membrane module or bank of membrane modules or an array of modules. A single-stage membrane separation operation is adequate for many applications. If the permeate stream requires further purification, it may be passed to a second bank of membrane modules for a second processing step. If the residue stream requires further concentration, it may be passed to a second bank of membrane modules for a second-stage treatment. Such multi-stage or multi-step processes, and variants thereof, will be familiar to those of skill in the art, who will appreciate that the membrane separation step may be configured in many possible ways, including single-stage, multi-stage, multi-step, or more complicated arrays of two or more units in serial or cascade arrangements.

Air stream 301, which is at atmospheric pressure (about 1 bar abs), flows as a feed stream across the feed surface of membrane 303. The permeate side of the membrane is maintained at lower pressure to provide a driving force for transmembrane permeation. Oxygen permeates the membrane preferentially, resulting in an oxygen-depleted residue stream, 304, and an oxygen-enriched permeate stream, 305. Typically, the feed side is maintained at a pressure within the range of about 0.9 bar abs to about 1.3 bar abs; preferably, within the range of about 0.95 bar abs to about 1.1 bar abs. The permeate side is typically maintained at a pressure within the range of about 0.4 bar abs to about 0.65 bar abs; preferably, within the range of about 0.45 bar abs to about 0.55 bar abs.

As is familiar to those of skill in the art, the separation performance achieved by the membrane depends on such factors, as the membrane selectivity, the pressure ratio between feed and permeate sides, and the membrane area. The transmembrane flux depends on the permeability of the membrane material, the pressure difference across the membrane, and the membrane thickness.

Oxygen-depleted residue stream 304 is withdrawn from the feed side of the membrane unit 302 and exhausted.

The permeate stream 305, which typically has an oxygen content that is at least about 26 vol % and, preferably, at least about 28 vol %, is withdrawn. The permeate stream 305 is then compressed in a turbo vacuum blower, 306, to a pressure of at least about atmospheric pressure.

A turbo vacuum blower (also known as a centrifugal or radial vacuum blower) is a type of vacuum pump used to exhaust large volumes of air from moderate vacuum. These pumps achieve a pressure rise by adding kinetic energy/velocity to a continuous flow of fluid through the rotor or impeller. This kinetic energy is then converted to an increase in potential energy/static pressure by slowing the flow through a diffuser.

Hot, oxygen-enriched air stream, 307, is withdrawn from turbo pump 306. This stream typically has an oxygen content that is at least about 26 vol % and, preferably, at least about 28 vol %, and is typically at a temperature within the range of about 110° C. to about 160° C. and, more typically, within the range of about 120° C. to about 140° C.

Hot oxygen-enriched air stream 307 can, now be sent for other uses, such as in a lime or cement kiln, or a glass furnace, a fuel (e.g., coal, oil, biomass, or natural gas) combustion or gasification process, or a sweep-based membrane separation process, for example and not by way of limitation. The use of oxygen-enriched air in sweep-based membrane separation processes is discussed, for example, in commonly owned U.S. Pat. Nos. 7,964,020; 8,114,192; and 8,025,715.

Alternatively, the hot oxygen-enriched air can be sent for use in a Claus process, which is a multi-step process that recovers elemental sulfur from gaseous hydrogen sulfide present in raw natural gas, and from the by-product hydrogen sulfide-containing gases derived from crude oil refining and other industrial processes. The by-product gases generally originate from physical and chemical gas treatment units (e.g., Selexol®, Rectisol®, Purisol®, and amine scrubbers) in refineries, natural gas processing plants, and gasification or synthesis gas plants.

In another application, the hot oxygen-enriched air can be sent for use in the catalyst regeneration step of a fluid catalytic cracking process. Fluid catalytic cracking (FCC) is used in petroleum refineries to convert the high boiling point, high molecular weight hydrocarbon fractions of petroleum crude oil to more valuable gasoline and olefinic gases, as well as other products. FCC has largely replaced thermal cracking as a means of cracking petroleum hydrocarbons, as FCC produces a greater quantity of gasoline with a higher octane rating, as well as by-product gases that are more olefinic, and therefore more valuable.

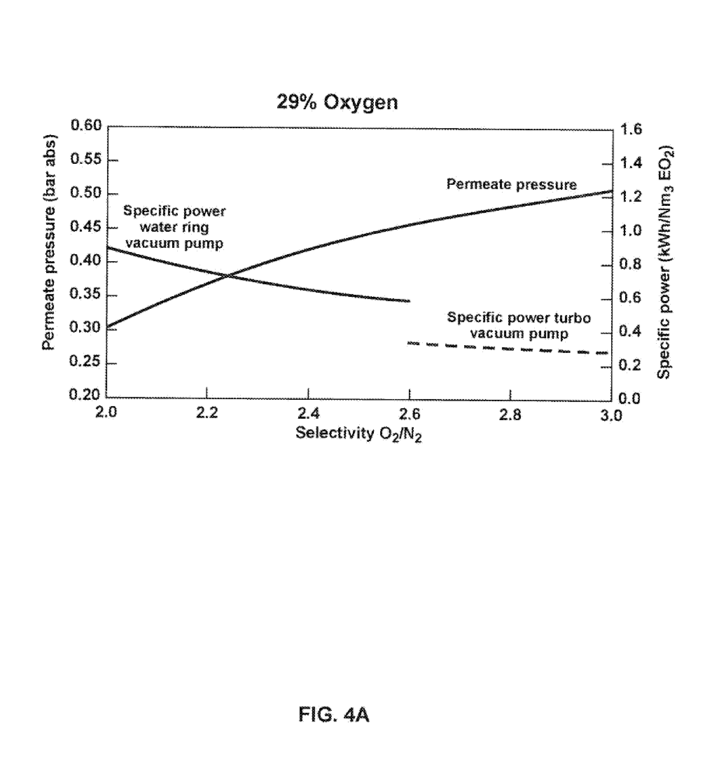

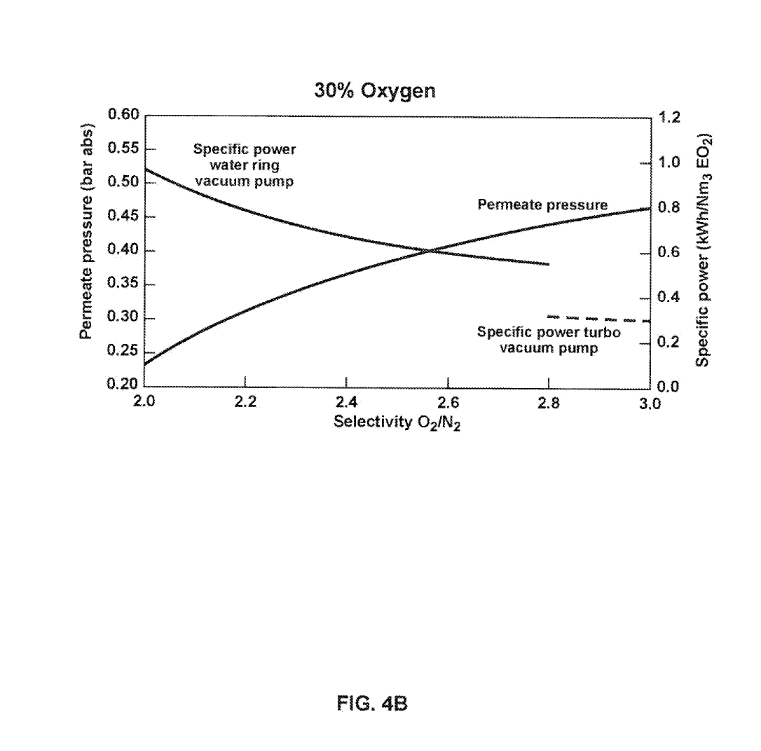

FIGS. 4A and 4B are graphs showing permeate pressure for, respectively, 29 vol % and 30 vol % oxygen-enriched air production processes, as well as specific power for a water ring vacuum pump process and a turbo vacuum blower process, as a function of oxygen/nitrogen membrane selectivity.

Note in each case that the turbo vacuum blower process operates at a much lower specific power than the water ring vacuum pump process. For example, for the 29 vol % oxygen-enriched air production process, at an oxygen/nitrogen selectivity of 2.6, specific power consumption for the water ring process was about 0.6 kWh/Nm³ EO₂ whereas, for the turbo process, specific power consumption was about 0.35 kWh/Nm³ EO₂. Accordingly, for the 30 vol % oxygen-enriched air production process, at an oxygen/nitrogen selectivity of 2.8, specific power generation for the water ring process was again about 0.53 kWh/Nm³ EO₂ whereas, for the turbo process, specific power generation was about 0.3 kWh/Nm³ EO₂.

The invention is now further described by the following examples, which are intended to be illustrative of the invention, but are not intended to limit the scope or underlying principles in any way.

### EXAMPLES

### Example 1

### Comparative Example: Conventional Membrane-Based Process for Producing Oxygen-Enriched Air (not in Accordance with the Invention)

The calculations that follow were performed using a computer process simulation program (ChemCad 6.32, ChemStations, Houston, Tex.) which was modified with differential element subroutines for the membrane separation steps.

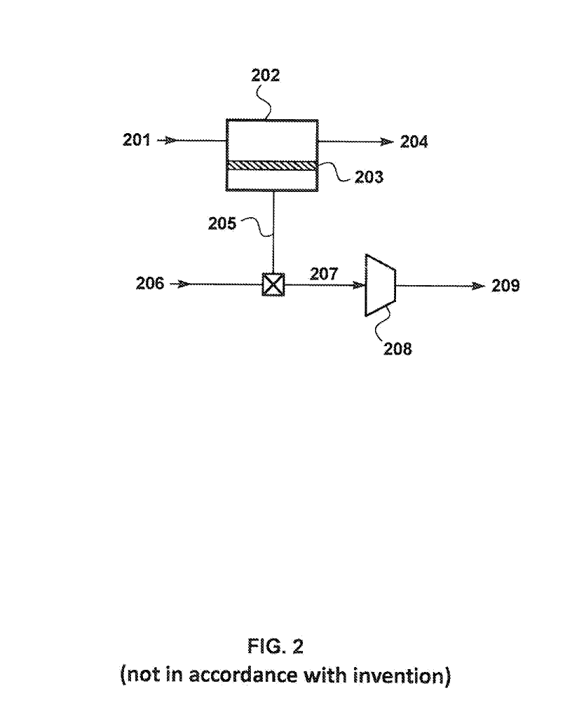

The calculation of Example 1 was performed according to the conventional oxygen-enriched air production process schematic illustrated in FIG. 2, which used a PDMS membrane with a 900 kW water ring vacuum pump. The membrane 203 was assumed to have an oxygen/nitrogen selectivity of 2 and a membrane area of 4,025 m². Stage cut was assumed to be 10%.

Results of the calculation are presented in Table 1.

TABLE 1
Conventional Process for Production of Oxygen-
enriched Air Using a Rubbery Membrane

| Stream Composition | Feed Air | Residue | Permeate | Product |
|---|---|---|---|---|
| (mol %) | (201) | (204) | (205) | (209) |
| Nitrogen | 77.8 | 78.9 | 67.9 | 68.4 |
| Oxygen | 20.7 | 19.8 | 28.9 | 29.1 |
| Water | 1.5 | 1.3 | 3.2 | 2.5 |
| Flow (Nm³/h) | 100,000 | 90,000 | 10,000 | 10,000 |
| Temp. (° C.) | 20 | 20 | 20 | 27 |
| Pressure (bar) | 1.0 | 1.0 | 0.25 | 1.0 |

The oxygen content of the air, was increased from approximately 21 mol % to approximately 29 mol %, but the process required an energy input of 900 kW.

### Example 2

### Process of the Invention for Producing Oxygen-Enriched Air

The calculation of Example 2 was performed according to the process of the invention for producing oxygen-enriched air illustrated in FIG. 3, which used a glassy polymeric membrane with a 400 kW turbo vacuum blower. The membrane 303 was assumed to have an oxygen/nitrogen selectivity of 2.5 and a membrane area of 3,635 m². Stage cut was assumed to be 10%.

Results of the calculation are presented in Table 2.

TABLE 2
Inventive Process for Production of Oxygen-
enriched Air Using a Glassy Polymer Membrane

| Stream Composition | Feed Air | Residue | Permeate | Product |
|---|---|---|---|---|
| (mol %) | (301) | (304) | (305) | (307) |
| Nitrogen | 77.8 | 78.9 | 68.6 | 68.6 |
| Oxygen | 20.7 | 19.8 | 28.9 | 28.9 |
| Water | 1.5 | 1.4 | 2.5 | 2.5 |
| Molar Flow (Nm³/h) | 100,000 | 90,000 | 10,000 | 10,000 |
| Temp. (° C.) | 20 | 20 | 20 | 130 |
| Pressure (bar) | 1.0 | 1.0 | 0.4 | 1.0 |

Again, the oxygen content of the air was increased from approximately 21 mol % to approximately 29 mol %, but the process required an energy input of only 400 kW—about 45% of the energy of the conventional process. Furthermore, the oxygen-enriched air exits the process hot (130° C.), which also reduces the fuel required for combustion gases to reach the required temperature. In addition, the more oxygen that the air contains, the easier it is to recover carbon dioxide for environmentally friendly sequestration, as the carbon dioxide will be at a higher partial pressure in the combustion product gas.

We claim:

1. A process for producing oxygen-enriched air comprising the following steps:
(a) providing a source of air;
(b) providing a membrane having a feed side and a permeate side, wherein the membrane has a selectivity for oxygen over nitrogen of at least 2.4;
(c) passing the air as a feed stream across the feed side of the membrane;
(d) withdrawing from the permeate side a permeate stream that is enriched in oxygen compared to the feed stream;
(e) compressing the permeate stream in a turbo vacuum blower; and
(f) withdrawing an oxygen-enriched air stream from the turbo vacuum blower exhaust.

2. A process in accordance with claim 1, wherein the membrane has a selectivity for oxygen over nitrogen of at least 2.5.

3. A process in accordance with claim 1, wherein the membrane has an oxygen permeance of at least about 2,000 gpu.

4. A process in accordance with claim 3, wherein the membrane has an oxygen permeance of at least about 3,000 gpu.

5. A process in accordance with claim 1, wherein the membrane has a selective layer comprising a hydrophobic fluorinated glassy polymer or copolymer.

6. A process in accordance with claim 1, wherein the permeate stream has an oxygen content that is at least about 26 vol %.

7. A process in accordance with claim 6, wherein the permeate stream has an oxygen content that is at least about 28 vol %.

8. A process in accordance with claim 1, wherein the permeate stream is compressed in the turbo vacuum blower from an absolute pressure of at least about 0.4 bar.

9. A process in accordance with claim 8, wherein the permeate stream is compressed in the turbo vacuum blower from an absolute pressure of at least about 0.5 bar.

10. A process in accordance with claim 8, wherein the permeate stream is compressed in the turbo vacuum blower to a pressure within the range of 0.9 bar absolute to 1.2 bar absolute.

11. A process in accordance with claim 1, wherein the oxygen-enriched air stream is at a temperature within the range of about 110° C. to about 160° C.

12. A process in accordance with claim 11, wherein the oxygen-enriched air stream is at a temperature within the range of about 120° C. to about 140° C.

13. A process in accordance with claim 1, wherein the oxygen-enriched air stream is sent for use in a lime or cement kiln or in a glass furnace.

14. A process in accordance with claim 1, wherein the oxygen-enriched air stream is sent for use in a fuel combustion process or a gasification process.

15. A process in accordance with claim 14, wherein the oxygen-enriched air stream is sent for use in a combustion process in which carbon dioxide is recovered from the combustion products for sequestration purposes.

16. A process in accordance with claim 1, wherein the oxygen-enriched air stream is sent for use in a Claus process.

17. A process in accordance with claim 1, wherein the oxygen-enriched air stream is sent for use in a fluid catalytic cracking process.

18. A process in accordance with claim 1, wherein the oxygen-enriched air stream is sent for use a sweep gas in a sweep-based membrane separation process.
